(19) United States
(12) Patent Application Publication
(10) Pub. No.: US 2021/0237353 A1
(43) Pub. Date: Aug. 5, 2021

(54) SYSTEM FOR MANUFACTURING A THREE-DIMENSIONAL OBJECT

(71) Applicant: Rapid Shape GmbH, Heimsheim (DE)

(72) Inventors: Andreas Schultheiss, Muehlacker (DE); Andreas Geitner, Leonberg (DE)

(21) Appl. No.: 17/248,747

(22) Filed: Feb. 5, 2021

Related U.S. Application Data
(63) Continuation of application No. PCT/EP2019/070958, filed on Aug. 5, 2019.

(30) Foreign Application Priority Data
Aug. 6, 2018 (DE) 10 2018 119 069.7

(51) Int. Cl. B29C 64/255; B33Y 30/00; B29C 64/25

(52) U.S. Cl. CPC B29C 64/255; B29C 64/25; B33Y 30/00

(57) ABSTRACT

A system for manufacturing a three-dimensional object by solidifying a material that is solidifiable under the effect of radiation, which system comprises a container for receiving the solidifiable material, in which container the solidifiable material is solidified in layers or continuously by the effect of radiation for manufacturing the three-dimensional object, wherein the container comprises a container base and a peripheral container wall projecting from the container base, wherein the container base and the container wall delimit a material receiving space for receiving the solidifiable material, wherein the container defines a container inner space surrounded by a container shroud, wherein the container inner space comprises the material receiving space, wherein the container shroud is closed, and wherein the container shroud comprises a support element, which defines a holding surface for holding the three-dimensional object made from the solidifiable material.

### CROSS-REFERENCE TO RELATED APPLICATIONS

This application is a continuation of international application number PCT/EP2019/070958 filed on Aug. 5, 2019 and claims the benefit of German application number 10 2018 119 069.7 filed on Aug. 6, 2018, which are incorporated herein by reference in their entirety and for all purposes.

### FIELD OF THE INVENTION

The present invention relates in general to systems for manufacturing a three-dimensional object by solidifying a material that is solidifiable under the effect of radiation, and in particular a system for manufacturing a three-dimensional object by solidifying, in particular in layers or continuously, a material that is solidifiable under the effect of radiation, which system comprises a container for receiving the solidifiable material, in which container the solidifiable material is solidified in layers or continuously by the effect of radiation for manufacturing the three-dimensional object, wherein the container comprises a container base and a peripheral container wall projecting from the container base, wherein the container base and the container wall delimit a material receiving space for receiving the solidifiable material.

### BACKGROUND OF THE INVENTION

Systems of the kind described at the outset are known, in particular, in the form of so-called 3D-printers, with which three-dimensional objects can be manufactured by solidifying in layers a resin solution that is polymerizable, e.g. by means of electromagnetic radiation, in particular in the ultraviolet spectral range.

One problem in the operation of such systems is, in particular, the cleaning of the container, which is typically of tray-shaped configuration and therefore is also referred to as a tray.

A further problem is, in particular, the contamination of parts of the system, for example a support device thereof on which the solidified three-dimensional object is held during the manufacturing process, with the material to be solidified. This is very often difficult to dispose of, in particular as special waste. Any contamination of the system with the material to be solidified requires a significant cleaning effort with cleaning devices and cleaning agents that can be used only specially for this purpose and then also have to be disposed of as special waste.

It is therefore desirable to simplify the operation of a system of the kind described at the outset and, in particular, the handling thereof.

### SUMMARY OF THE INVENTION

In a first aspect of the invention, a system for manufacturing a three-dimensional object by solidifying, in particular in layers or continuously, a material that is solidifiable under the effect of radiation comprises a container for receiving the solidifiable material, in which container the solidifiable material is solidified in layers or continuously under the effect of radiation for manufacturing the three-dimensional object. The container comprises a container base and a peripheral container wall projecting from the container base. The container base and the container wall delimit a material receiving space for receiving the solidifiable material. The container defines a container inner space surrounded by a container shroud. The container inner space comprises the material receiving space. The container shroud is closed and the container shroud comprises a support element, which defines a holding surface for holding the three-dimensional object formed from the solidifiable material.

### BRIEF DESCRIPTION OF THE DRAWING FIGURES

The foregoing summary and the following description may be better understood in conjunction with the drawing figures, of which:

FIG. 1: shows a schematic depiction of an embodiment of a system for manufacturing a three-dimensional object;

FIG. 2: shows a schematic depiction of an embodiment of a container for receiving solidifiable material;

FIG. 3: shows a schematic depiction of a further embodiment of a container;

FIG. 4: shows a schematic depiction of a section of a base of a further embodiment of a container;

FIG. 5: shows a schematic depiction of a further embodiment of a container, which is held with a holding device of the system;

FIG. 6: shows a schematic depiction of a further embodiment of a container;

FIG. 7: shows a schematic depiction of a further embodiment of a container;

FIG. 8: shows a schematic depiction of a further embodiment of a container;

FIG. 9: shows a schematic depiction of a partial view of a further embodiment of a container;

FIG. 10: shows a schematic depiction of a partial view of a further embodiment of a container;

FIG. 11: shows a schematic depiction of a partial view of a further embodiment of a container with a connecting device;

FIG. 12: shows a schematic depiction of a partial view of a further embodiment of a container with a connecting device;

FIG. 13: shows a schematic depiction of a partial view of a further embodiment of a container with a connecting device;

FIG. 14: shows a schematic depiction of a partial view of a further embodiment of a container with a connecting device;

FIG. 15: shows a schematic depiction of a partial view of a further embodiment of a container with a connecting device;

FIG. 16: shows a schematic depiction of a partial view of a further embodiment of a container with a connecting device;

FIG. 17: shows a schematic depiction of a sectional view of a further embodiment of a container with a tensioning device;

FIG. 18: shows a schematic depiction of a sectional view of a further embodiment of a container;

FIG. 19: shows a schematic depiction of a sectional view of a part of a further embodiment of the system in the region of the support device;

FIG. 20: shows a schematic depiction of a partial view of an embodiment of a structured support element;

FIG. 21: shows a schematic depiction of a part of a further embodiment of a support device of a further embodiment of a system with a support device cover;

FIG. 22: shows a schematic depiction of a part of a further embodiment of a support device of a further embodiment of a system with a support device cover;

FIG. 23: shows a schematic depiction of a part of a further embodiment of a support device of a further embodiment of a system with a support device cover;

FIG. 24: shows a schematic depiction of a part of a further embodiment of a support device of a further embodiment of a system with a support device cover;

FIG. 25: shows a schematic depiction of a partial view of a further embodiment of a system with a partial view of a support device and a container;

FIG. 26: shows a schematic depiction of a part of a further embodiment of a support device with a support element coupled thereto;

FIG. 27: shows a schematic depiction of a part of a further embodiment of a support device with a support element coupled thereto;

FIG. 28: shows a schematic depiction of an embodiment of a material container with solidifiable material;

FIG. 29: shows a schematic depiction of a part of a further embodiment of a system with a container comprising a closed container shroud;

FIG. 30: shows a schematic depiction of a part of a further embodiment of a system with a container comprising a closed container shroud;

FIG. 31: shows a schematic depiction of a partial sectional view of a further embodiment of a container with a container shroud having an interface device; and

FIG. 32: shows a schematic depiction of a further embodiment of a material container with a predetermined breaking point.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The invention relates to a system for manufacturing a three-dimensional object by solidifying, in particular in layers or continuously, a material that is solidifiable under the effect of radiation, which system comprises a container for receiving the solidifiable material, in which container the solidifiable material is solidified in layers or continuously under the effect of radiation for manufacturing the three-dimensional object, wherein the container comprises a container base and a peripheral container wall projecting from the container base, wherein the container base and the container wall delimit a material receiving space for receiving the solidifiable material, wherein the container defines a container inner space surrounded by a container shroud, wherein the container inner space comprises the material receiving space, wherein the container shroud is closed, and wherein the container shroud comprises a support element, which defines a holding surface for holding the three-dimensional object formed from the solidifiable material.

A system of the kind described at the outset that has been further developed in the proposed manner has the advantage, in particular, that the three-dimensional object is manufactured in the container inner space, i.e. completely surrounded by the container shroud. Thus the solidifiable material is also surrounded by the container shroud during the manufacture of the three-dimensional object. Thus, in particular, an odor nuisance during the operation of the system is minimized or even excluded. Further, a contamination of the system with the solidifiable material can be practically excluded by this configuration. With such a container, in particular three-dimensional objects can be formed and then, when they are completely solidified, the container can be removed as a whole from the system. The container shroud can then be opened in the desired manner in order to remove the three-dimensional object from the container. For this purpose, the container shroud may, for example, be of reclosable configuration, in particular having an opening that can be opened and reclosed in the manner of a zipper. By means of the support element, which is comprised by the container shroud, the solidified three-dimensional object that is held on the holding surface is formed in the interior of the container shroud, hence in the container inner space. The container thus forms a sort of capsule that is inserted in the system before the formation of a three-dimensional object and can be removed from the system after completed formation of the three-dimensional object. Three-dimensional objects can be formed in a simple and clean manner in this way. The handling of a system of the kind described at the outset can, in particular, be significantly simplified in this way.

It is favorable if the container base and/or the container wall form part of the container shroud. This makes it possible, in particular, to insert the container in one piece into the system, for example to couple the support element of the container to a support device of the system and to bring the container into engagement with a holding device of the system for holding the container in the desired manner.

It is favorable if the container has an interface device arranged on the container shroud for introducing the solidifiable material through the container shroud into the container inner space. The interface device makes it possible, in particular, to fill the container with the solidifiable material in a simple manner. Thus, in particular only as much of the solidifiable material as is actually required for the formation of the three-dimensional object can be filled into the container. This enables a resource-saving and environmentally friendly operation of the system.

The system can be configured in a simple manner if the interface device comprises an opening and/or a semipermeable membrane. In particular, the membrane may be of pierceable configuration. The solidifiable material can be introduced in a simple manner through the opening into the container inner space and thus into the material receiving space of the container. A membrane can be pierced e.g. with a cannula and thus the solidifiable material can be introduced into the material receiving space by injection. The opening may, in particular, be of closeable configuration, for example by means of a closure element in the form of a lid. The opening can thus be reclosed after filling the material receiving space with the solidifiable material. In particular, the container can thus be of gas-tight and odor-tight configuration and be used for manufacturing the three-dimensional object.

The interface device preferably comprises a threaded portion or a bayonet connection for releasably connecting to a corresponding material container interface device of a material container filled with solidifiable material. An interface device of that kind enables, in particular, a fluid-tight coupling to the material container in order to be able to introduce the solidifiable material into the material receiving space of the container quickly and cleanly. A contamination of the system, in particular of the container from the outside, when filling the container with solidifiable material can thus be practically completely prevented.

It is advantageous if the interface device is arranged or formed at a distance from the container base. In particular, it is preferably not arranged or formed in the container wall. Such an arrangement of the interface device makes it possible, in particular, to provide no direct access to the material receiving space on the container shroud in the region of the container base and the container wall. Points of the interface device that are not tight then cannot lead to the solidifiable material being able to leak out of the container in an undesired manner and contaminate the system or components thereof.

It is advantageous if the interface device is arranged or formed in or on the container wall. Such an arrangement is advantageous in particular if the container wall, i.e. that which delimits the material receiving space, is configured to be more stable than the container shroud without the container base and the container wall.

The container base is advantageously made from a different material than the container wall. This has the advantage, in particular, that the container base can be made from a container base material that adheres poorly to the solidified solidifiable material or can be easily removed therefrom. The container wall may be formed, in particular, from a container wall material that has the necessary stability to keep the solidifiable material in the container. Further, the container base may be formed from a material that optimally is transmissive to the radiation used to solidify the solidifiable material. The respective optimal materials can thus be used for the container wall and the container base. Compromises are not necessary.

It is advantageous if the container base is configured to be transmissive to the radiation used to solidify the solidifiable material. In particular, it may be transmissive to electromagnetic radiation in a wavelength range of about 700 nm to about 1000 nm. A container base of that kind makes it possible, in particular, to expose the solidifiable material to light through the container base to form the three-dimensional object.

The container base is preferably configured in the form of a separating element. A separating element in this sense makes it possible, in particular, to be easily removed from the solidified three-dimensional object. To form the three-dimensional object, typically a thin layer of the non-solidified solidifiable material between the last solidified layer of the three-dimensional object and the container base is subjected to suitable radiation. This leads to the container base being joined to or adhering to the three-dimensional object after this layer of solidifiable material has hardened. To be able to form a further layer of the three-dimensional object, the three-dimensional object, provided it is already solidified, must then be moved away from the container base, i.e. be separated therefrom, so that not yet solidified solidifiable material can flow between the three-dimensional object and the container base. Such a separating element thus makes it possible, in particular, to remove or detach same from the three-dimensional object in a simple manner.

It is advantageous if the container base is provided with a non-stick layer delimiting the material receiving space or if the container base is made from a container base material that does not stick or sticks little to the solidified material. Such further development makes it possible, in particular, to detach the container base from the object in a simple manner after the formation of a solidified layer of the three-dimensional object that is adhered to the container base or is in contact therewith. In particular, such a container base may form a separating element in the sense described above.

The detachment of the container base from the three-dimensional solidified object can be achieved in a particularly simple manner if the container base is configured in the form of a film or is made from a film. Such a film has the property, in particular, of being flexible and/or elastic, depending on the material from which it is made. It is also producible thinly and thus cost-effectively. Further, it can be easily connected to the container wall in an untensioned or tensionless manner. However, in particular, it can also be tensioned in the desired manner, if necessary, in order to define a defined container base surface that delimits the material receiving space. This container base surface may be planar or curved.

It is favorable if the container base is of elastic and/or flexible configuration. The flexible and/or elastic configuration of the container base makes it possible, in particular, to detach the container base from the solidified material of the three-dimensional object, namely in a simple manner, if a further layer of the three-dimensional object is solidified and the solidified three-dimensional object is moved step-wise out of the solidifiable material. Thus, not yet solidified solidifiable material can flow between the container base and the last solidified layer of the three-dimensional object and be solidified by exposure to radiation.

The container base preferably has a thickness in a range of about 0.05 mm to about 3 mm. In particular, it may have a thickness in a range of about 0.07 mm to about 0.3 mm. Forming container bases with such thicknesses makes it possible, in particular, to configure same elastically and/or flexibly, and to connect same to the container wall in a tensionless or tension-free manner. Further, a thin container base has the advantage that it is particularly well-permeable to the radiation required to solidify the solidifiable material.

The container base can be made from a plastic in a simple and cost-effective manner. In particular, the plastic may be polytetrafluoroethylene (PTFE), perfluoroalkoxy polymer (PFA), ethylene tetrafluoroethylene copolymer (ETFE) and/or tetrafluoroethylene hexafluoropropylene copolymer (FEP). In particular, a container base made of plastic makes it possible to produce same in a simple and cost-effective manner. Such a container base may, in particular, be of flexible and/or elastic configuration. In addition, the explicitly mentioned plastics or combinations of plastics make it possible to configure the container base in the form of a separating element, as described above, which can be easily detached, i.e. without much effort, from the three-dimensional object after the last exposed layer of said three-dimensional object has hardened.

The container can be configured in a simple manner if the container wall extends perpendicularly or substantially perpendicularly away from the container base. Substantially perpendicular means, in particular, an inclination of about +/−10 degrees in relation to the perpendicular.

In order to increase the stability of the container, it is advantageous if the container wall is configured to be self-supporting. In particular, it may be configured in the form of a self-enclosed annular container wall frame.

In accordance with a further embodiment, provision may be made for the container shroud to be made at least partially from a film, wherein in particular the film is of elastic and/or flexible configuration. In particular, the entire container shroud may be made from a film. Such a container shroud is also very light and can be produced with little use of material. In particular, it can thus be disposed of in a relatively inexpensive and environmentally-friendly manner.

It is advantageous if the container shroud has a thickness in a range of about 0.05 mm to about 1.5 mm. In particular, it may have a thickness in a range of about 0.1 mm to about 0.6 mm. Container shrouds, in particular also the container wall comprised by the container shroud, with a thickness in the specified ranges have, in particular, the stated properties, namely depending on the material from which they are formed, of being either self-supporting or not self-supporting.

The container can be formed in a simple and cost-effective manner if the container shroud is made from a plastic.

The handling of the system can, in particular, further be simplified by the container shroud being formed in one piece. In particular, it may be formed in one piece, except for the container base. This makes it possible, in particular, to form the container base from a different material than the rest of the container shroud.

In order to be able to form the three-dimensional object solidified by irradiation in the container inner space in a simple and secure manner, it is advantageous if the support element is arranged or formed opposite or substantially opposite the container base. This makes it possible, in particular, to move the support element by way of a support device coupled thereto in the direction toward the container base, that is to say into the solidifiable material contained in the material receiving space of the container, and to remove it therefrom.

In order to manufacture the three-dimensional object from the solidifiable material by means of curing and to move it step-wise out of said solidifiable material, it is favorable if the holding surface is arranged or formed facing in the direction or substantially in the direction toward the container base. Further developing a system in this way has the advantage, in particular, that the manufactured three-dimensional object together with the support element can be removed from the support device of the system. Due to the configuration of the container with a container shroud, a contamination of the support device with the solidifiable material can also be prevented. A cleaning of the support device is no longer necessary due to the proposed further development.

It is advantageous if the support element is configured to releasably couple to a movably configured or arranged support device of the system in a coupling position. This configuration makes it possible, in particular, to decouple the support element from the support device when the three-dimensional object is completed. The support element protects the support device from a contamination with the solidifiable material, such that the support device does not have to be cleaned. This system is then more quickly ready for use again. A new support element merely has to be coupled to the support device.

It is favorable if the support element comprises at least one first support element coupling element, which in the coupling position is in force- and/or positive-locking engagement with at least one second support element coupling element of the support device. Such a support element can, in particular, be easily and securely coupled to the support device and can be decoupled again from the support device to remove the three-dimensional object from the system after the manufacture of said object.

It is advantageous if the holding surface, in particular in the coupling position, is of planar or substantially planar configuration or if the holding surface is of structured configuration, in particular comprising a plurality of stabilization grooves. A structure of the holding surface can be arbitrary, in principle. Alternatively to the stabilization grooves, in particular pot-shaped or pyramidal, regularly arranged recesses may be formed, which give the support element an inherent stability, such that is substantially self-supporting.

It is advantageous if the container shroud comprises a support device cover for a support device of the system and if the support device cover comprises the support element. Providing such a support device cover has the advantage, in particular, that the support device can be significantly better protected from contamination with the solidifiable material than a support element that is of substantially plate- or layer-shaped configuration. A support device cover can, in particular, surround the support device, for example a holding plate thereof, laterally and in particular peripherally, such that the support device, i.e. in particular the holding plate thereof, can dip at least partially into the solidifiable material that is accommodated in the material receiving space of the container without the support device itself being contaminated with the solidifiable material. The support element forms in the proposed manner an integral part of the support device cover. The support element may, in particular, be connected to the support device cover in a force-locking and/or positive-locking and/or substance-to-substance bonded manner.

It is favorable if the support device cover defines a support device receptacle, into which the support device or a part thereof is at least partially introducible in a positive-locking or substantially positive-locking manner. In particular, the support device receptacle may form part of a tray-shaped support device cover. The support element can thus, in particular, define a base of the tray-shaped support device cover, wherein the holding surface then, in particular, defines a base surface of the support device cover facing away from the support device receptacle.

The support device can be protected from contamination with solidifiable material in a simple manner if the support device cover is configured in the form of a sheath or a deep-drawn blister, which comprise or define the support device receptacle. The support device cover can thus be pulled or slipped over the support device in a simple manner.

The system can be configured in a particularly simple and cost-effective manner if the support device cover is made from a plastic.

In accordance with a further embodiment, provision may be made that the support device cover has a peripheral, radially protruding retaining flange or a peripheral, radially projecting retaining edge, which retaining flange or retaining edge in the coupling position runs transversely, in particular perpendicularly, to the direction of gravity. Such a support device cover forms with the retaining flange or the retaining edge a sort of stop for the solidifiable material when the carrier device dips in, the latter being protected from contamination by the support device cover. It can thus be prevented, in particular, that the solidifiable material is able to flow laterally around the support device and thus contaminate it.

In order to be able to cure the solidifiable material in layers to form the three-dimensional object, in particular in a defined building plane, it is advantageous if the support element and the container base are arranged or formed so as to be movable relative to one another. For example, the support element or the container base or both the support element and the container base can be moved by means of the support device in order to achieve the desired relative movement between the support element and the container base.

In order to be able to manufacture three-dimensional objects from a solidifiable material, it is advantageous if the system comprises a material container filled with solidifiable material. Said material container may, in particular, be formed and also provided separately, i.e. spatially separated, from the container.

The system can be of particularly compact configuration if the material container is comprised by the container. In particular, for example, a wall of the material container may be formed by the container shroud, in particular by a portion of the container wall and/or a portion of the container base.

A completely closed system can be formed, in particular, by the material container being arranged or formed at least partially, in particular completely, in the material receiving space defined by the container. The solidifiable material can then be introduced, for example, from the material container into the material receiving space by the material container being opened. For example, to this end, the material container may have a corresponding closure that can be opened, and in particular also closed again, at least once.

In order to be able to use the material container preferably only once, in particular only a few times, to produce one or more three-dimensional objects, it is advantageous if the material container has at least one predetermined breaking point for opening same. A predetermined breaking point makes it possible, in particular, to irreversibly open the material container in order to transfer the solidifiable material contained in the material container into the material receiving space of the container.

It is favorable if the material container comprises a material container interface device for coupling, in particular for coupling in a fluid-tight manner, to the interface device of the container in a filling position. This further development makes it possible, in particular, to prevent the leakage of solidifiable material when filling the material container. Fluid-tight may mean, in particular, both liquid-tight and gas-tight. A gas-tight coupling in the filling position has the advantage, in particular, that there is no odor nuisance when operating the system.

In accordance with a further embodiment, provision may be made for the container shroud to be openable only by means of destruction for removing the solidified three-dimensional object. For example, the container shroud may have a container shroud predetermined breaking point that can be irreversibly destroyed for opening the container shroud in a defined manner. In particular, it can thus be achieved that the container as a whole is no longer useful after opening the container shroud. For disposal, the not yet solidified solidifiable material remaining in the material receiving space of the container can then be exposed to light and thus cured so that it can be disposed of in an environmentally friendly manner.

Further, it may be advantageous if the container shroud, with the exception of the container base, is configured to be impermeable or substantially impermeable to the radiation used to solidify the solidifiable material. In particular, the container shroud in the stated region may be impermeable to electromagnetic radiation in a wavelength range of about 200 nm to about 1000 nm. This configuration can prevent, in particular, the solidifiable material being able to cure in the material receiving space in an undefined manner if radiation unintentionally penetrates the container shroud.

In order to protect the solidifiable material from an undesired solidification, it is advantageous if the container shroud, except for the container base, has a transmittance of at most 10%, in particular at most 1%, for the radiation used to solidify the solidifiable material, in particular for electromagnetic radiation in a wavelength range of about 200 nm to about 1000 nm. Such a container shroud can thus be penetrated only by the radiation used to solidify the solidifiable material, such that the container shroud may still be transparent enough for a user of the system to be able to see a filling level of the solidifiable material in the material receiving space, but without there being a risk of the solidifiable material being able to cure in an undefined manner.

Further, it is favorable if the system comprises a holding device for holding the container, such that the container base is arranged in space transversely, in particular perpendicularly to the direction of gravity and the container wall extends away from the container base counter or substantially counter to the direction of gravity. Such a holding device makes it possible, in particular in a simple manner, to hold the container in a defined manner, for example when it is filled with material to be solidified, in order to form by means of irradiation three-dimensional objects from the material to be solidified.

It is favorable if the system comprises a support device and a drive device that cooperates with the support device for moving the support device, in particular the support element in the coupling position, relative to the container base. In particular, for controlling the drive device, the system may comprise a corresponding control device, which moves the support device and thus the support element coupled thereto in a defined manner, in particular in steps or continuously, in order to form the three-dimensional object. In particular, the support element can thus, for example, be moved so far into the material receiving space that it can dip into the solidifiable material accommodated therein.

It is advantageous if the drive device is configured to move the support element in the coupling position in parallel or substantially in parallel to the direction of gravity in the direction toward the container base and away from the container base. In this way, the support element can be moved as described in order to form the three-dimensional object in the known manner. Further, it is advantageous if the system comprises an exposure device for exposing the solidifiable material to light, in particular in layers or continuously, by subjecting it to radiation, in particular electromagnetic radiation. Thus, in particular, a compact system can be formed, for example in the form of an autonomously operable 3D-printer.

To produce the radiation, it is favorable if the exposure device comprises a radiation source. For example, it may be an LED light source.

In order to avoid an expensive cleaning of the container, it is advantageous if the container is configured in the form of a disposable container. Such a container can be used once or a few times to form three-dimensional objects. The closed container can be opened, in particular irreversibly, to remove the produced three-dimensional object. When the container is no longer intended for use, not yet solidified solidifiable material that is adhering to the container at any location, for example on the support element or on the container base or on the container wall, can be hardened by appropriate irradiation so that it can be disposed of in a simple and environmentally friendly manner.

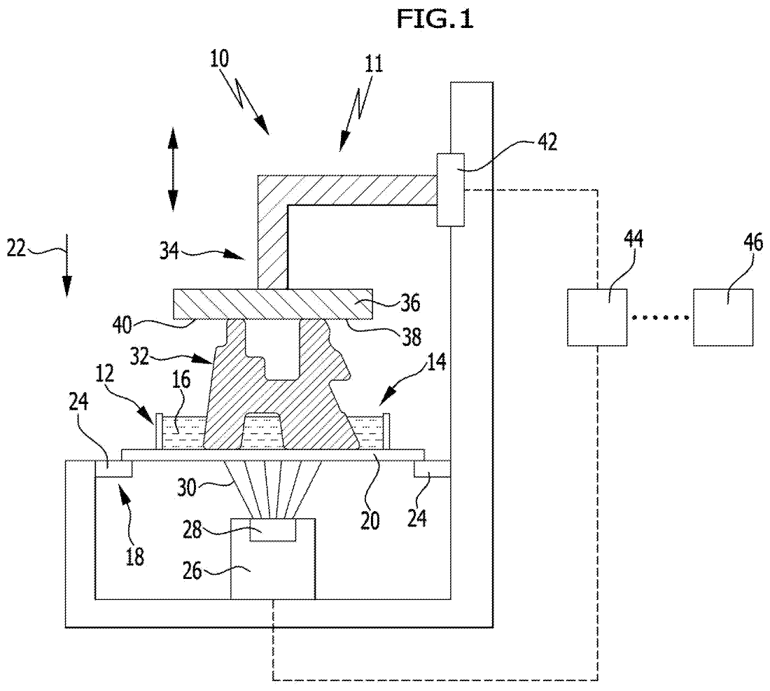

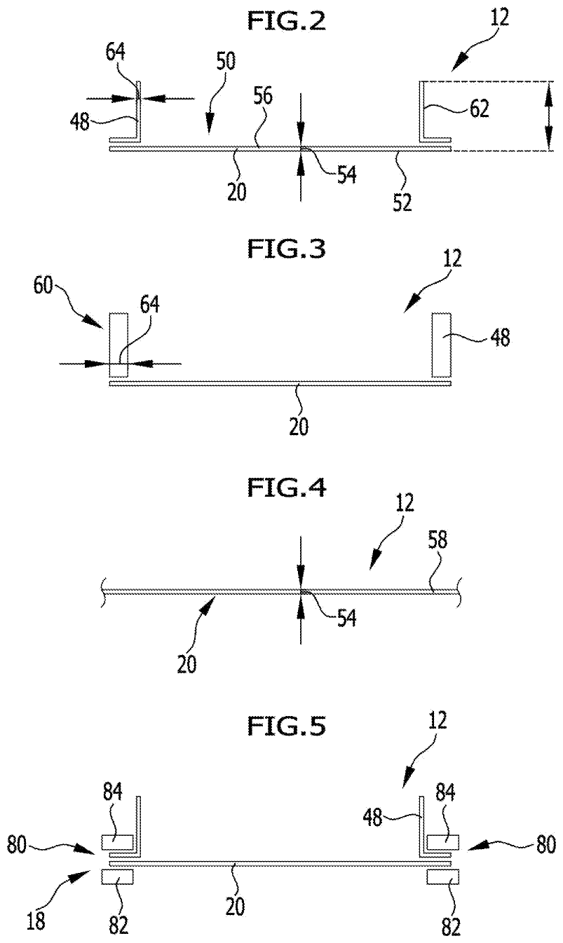

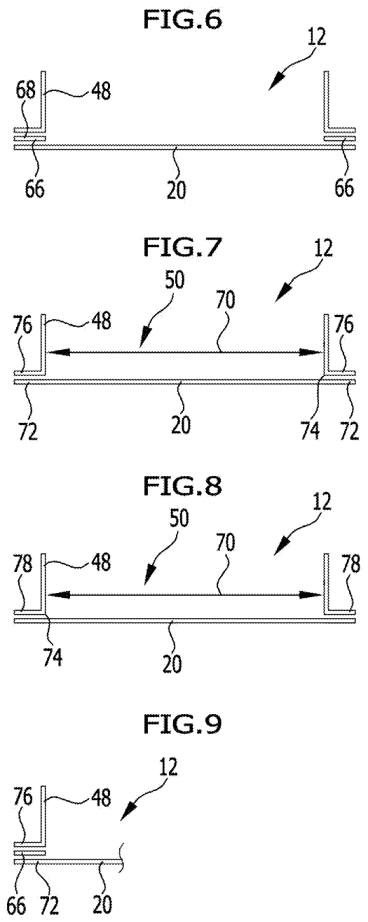

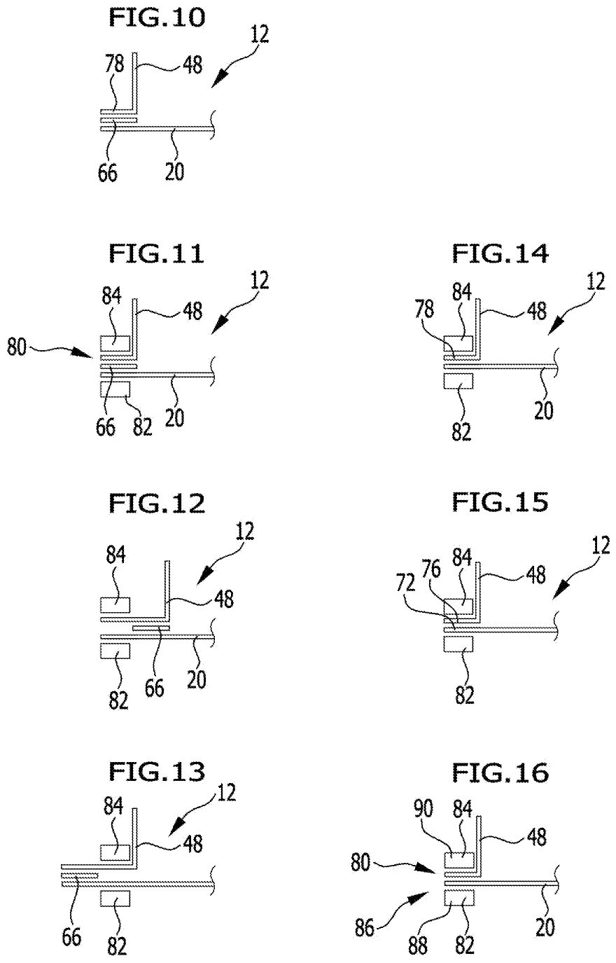

A first embodiment of a system for manufacturing a three-dimensional object in the form of a 3D-printer 11 is schematically depicted in FIG. 1 and is designated as a whole with the reference numeral 10.

It comprises a container 12 in the form of a flat tray 14 for receiving the solidifiable material 16. This may be, for example, a liquid plastic, in particular a polymerizable resin, which is solidifiable by being exposed to radiation 30.

The system 10 further comprises a holding device 18 for holding the container 12 in such a way that a container base 20 extends transversely, in particular perpendicularly to the direction of gravity symbolized by the arrow 22.

In known systems 10, the container bae 20 is typically made from a glass plate, which rests on supports 24 of the holding device 18.

The system 10 further comprises an exposure device 26 for exposing the solidifiable material 16 to light. To this end, the exposure device 26 comprises a radiation source 28 for producing radiation 30.

The exposure device 26 is arranged, in particular, in such a way that the radiation 30 produced can act upon the solidifiable material 16 through the container base 20.

To manufacture a three-dimensional object 32, the system 10 further comprises a support device 34, which may comprise, e.g., a holding plate 36.

The support device 34 is arranged in such a way that the holding plate 36 is arranged above the container 12 against the direction of gravity and an underside 38 of the holding plate 36 defines a holding surface 40, which is arranged facing in the direction toward the container 12 and is oriented in parallel or substantially in parallel to the container base 20.

The support device 34 is arranged or formed cooperating with a drive device 42 in order to, in particular, displace the holding plate 36 in parallel or substantially in parallel to the direction of gravity as well as against the direction of gravity.

The drive device 42 and the exposure device 26 are control-operatively connected to a control device 44. The control device 44 in turn is control-operatively connected to a computer 46.

Data that define the three-dimensional object 32 to be manufactured are transmitted by the computer 46 in a suitable manner to the control device 44, such that the control device 44 can appropriately control the exposure device 26 in order to expose to light and thereby solidify a layer of the solidifiable material 16 directly adjoining the container base 20.

Only those regions of the layer of solidifiable material 16 that are to form a corresponding layer of the three-dimensional object after curing are exposed to light.

The first layer that is solidified adheres directly to the holding surface 40 of the holding plate 36.

The three-dimensional object 32 is formed in layers or continuously by hardening the solidifiable material 16, wherein the drive device 42 moves the support device 34 in steps or continuously against the direction of gravity away from the container 12, such that the three-dimensional object 32 is formed out of the container 12, as is schematically depicted in FIG. 1.

In order to improve and simplify the handling of the system 10, in particular in conjunction with the handling of the solidifiable material as well as components of the system 10 that come into contact therewith, embodiments of further developed systems 10 are described in the following, namely in particular as a total system or as individual components thereof.

In one embodiment of the system 10, the container 12 comprises a container base 20 and a peripheral container wall 48 projecting from the container base 20. The container base 20 and the container wall 48 delimit a material receiving space 50 for receiving the solidifiable material 16.

In one embodiment of a container 12, the container base 20 is made from a different material than the container wall 48.

In a further embodiment of a container 12, the container base 20 is of elastic and/or flexible configuration and is connected to the container wall 48 in an untensioned or tensionless manner. In this context, untensioned or tensionless means that the container base 20 would deform in an undefined manner upon filling the solidifiable material into the material receiving space 50. In this case, the container base 20 is comparable in its properties to a drum head, which before being attached and tensioned on a drum housing is more or less freely deformable and is tensioned in a desired manner only by the tensioning device provided on the drum.

The container base 20 is configured to be transmissive to the radiation 30 used to solidify the solidifiable material. In one embodiment of a container 12, the container base 20 is transmissive to electromagnetic radiation 30 in a wavelength range of about 200 nm to about 1000 nm.

In one embodiment of a container 12, the container base 20 is configured in the form of a film 52 or is made from a film 52.

The container base 20 in one embodiment of a container 12 has a thickness 54 in a range of about 0.05 mm to about 3 mm. In particular, the container base 20 may have a thickness 54 in a range of about 0.07 mm to about 0.3 mm.

In one embodiment of a container 12, the container base 20 is made from a plastic. The plastic may be or contain, in particular, polytetrafluoroethylene (PTFE), perfluoroalkoxy polymer (PFA), ethylene tetrafluoroethylene copolymer (ETFE) and/or tetrafluoroethylene hexafluoropropylene copolymer (FEP).

In one embodiment of a container 12, the container base 20 is configured in the form of a separating element 56.

So that the container base 20 can take on the function of a separating element 56, which does not adhere or only adheres poorly to the three-dimensional object 32, namely to the last solidified layer thereof, in one embodiment of a container 12 the container base 20 is provided with a non-stick layer 58 delimiting the material receiving space 50.

In another embodiment of a container 12, the container base 20 is made from a container base material that does not adhere or only adheres poorly to the solidified material 16. That may, in particular, be the same material as that from which the non-stick layer 58 is made.

In one embodiment of a container 12, the container wall 48 is of self-supporting configuration, namely in the form of a self-enclosed annular container wall frame 60. Such an example is schematically depicted in FIG. 3 in cross section.

Alternatively, in one embodiment of a container 12, the container wall 48 is made from a film 62. The film 62 is of elastic and/or flexible configuration.

In the described embodiments of containers 12, a thickness 64 of the container wall 48 is in a range of about 0.05 mm to about 1.5 mm. In particular, the thickness 64 is in a range of about 0.1 mm to about 0.6 mm.

The container wall 48, in one embodiment of a container 12, is made from a plastic, for example a plastic that can be deep-drawn or extruded.

The container wall 48 and the container base 20 are connected to one another. The connection is preferably achieved in a force-locking and/or substance-to-substance bonded and/or positive-locking manner.

In one embodiment of a container 12, a substance-to-substance bond is achieved by means of a connecting layer 66. The connecting layer 66 may, in particular, be made from a plastic and/or comprise one or more adhesives.

In one embodiment of a container 12, the connecting layer 66 is configured in the form of a double-sided adhesive tape 68.

In a further embodiment of a container 12, the container wall 48 is of sleeve-shaped configuration and defines an inner cross sectional area 70. The container base 20 has two or more flange portions 72 that are spatially separated from one another. In particular, they face in mutually opposite directions. The flange portions 72 project laterally over the container wall 48.

The container wall 48 has a free end 74 facing toward the container base 20, on which end two or more container wall flange portions 76 that are spatially separated from one another are arranged or formed, which, in particular, face in mutually opposite directions. The container wall flange portions 76 extend away from the material receiving space 50, namely in parallel and substantially parallel to the container base 20.

In a further embodiment of a container 12, the container wall 48 is of sleeve-shaped configuration and defines an inner cross sectional area 70. The container base 48 projects laterally on all sides over the sleeve-shaped container wall 48. A free end 74 of the container wall 48 that faces toward the container base 20 is configured in the form of a peripheral container wall flange 78 extending away from the material receiving space 50 in parallel or substantially in parallel to the container base 20.

In one embodiment of a container 12, the connecting layer 66 is arranged or formed between the two or more flange portions 72 and the two or more container wall flange portions 76.

In a further embodiment of a container 12, the connecting layer 66 is arranged or formed between the container base 20 and the container wall flange 78.

A further embodiment of a system 10 comprises a connecting device 80 for connecting the container base 20 and the container wall 48 in a connecting position in a force- and/or positive-locking manner.

In a further embodiment of a system 10, the connecting device 80 comprises one or more first connecting elements 82 and one or more second connecting elements 84. The first and second connecting element 82 and 84 are arranged cooperatively to connect between them the container base 20 and the container wall 48 in the connecting position in a force- and/or positively-locking manner.

In one embodiment of a system 10, the connecting layer 66 in the connecting position is arranged between the first and second connecting elements 82 and 84.

In a further embodiment of a system 10, in the connecting position, no connecting layer 66 of the container 12 is arranged between the first and second connecting elements 82 and 84. The connecting elements 82 and 84 in this case are arranged further away from the container wall 48 than the connecting layer 66.

In a further embodiment of a system 10, in which no connecting layer 66 of the container 12 is arranged between the connecting elements 82 and 84, the connecting layer 66 is arranged further away from the container wall 48 than the connecting elements 82 and 84.

In one embodiment of a container 12, the first connecting elements 82 engage directly on the container base 20 and the second connecting elements 84 engage directly on the container wall flange 78.

In a further embodiment of a system 10, the first connecting elements 82 engage directly or indirectly on one or more flange portions 72, the second connecting elements 84 in the connecting position engage directly on one or more of the two container wall flange portions 76.

In one embodiment of a system 10, the connecting device 80 is configured in the form of a clamping device 86. The first connecting elements 82 in this case form first clamping elements 88, and the second connecting elements 84 form second clamping elements 90.

In a further embodiment of a system 10, the connecting device 80 is configured in the form of a tensioning device 92 for tensioning the container base 20 in a planar or curved manner. If the container base 20 is tensioned in a planar manner, it defines a container base plane 94. In one embodiment of a system 10, said container base plane extends perpendicularly to the direction of gravity.

In one embodiment of a system 10, the tensioning device 92 comprises one or more first tensioning elements 96 and one or more second tensioning elements 98, which are arranged or formed cooperatively. The one or more first connecting elements 82 form or comprise the one or more first tensioning elements 96. The one or more second connecting elements 84 form or comprise the one or more second tensioning elements 98.

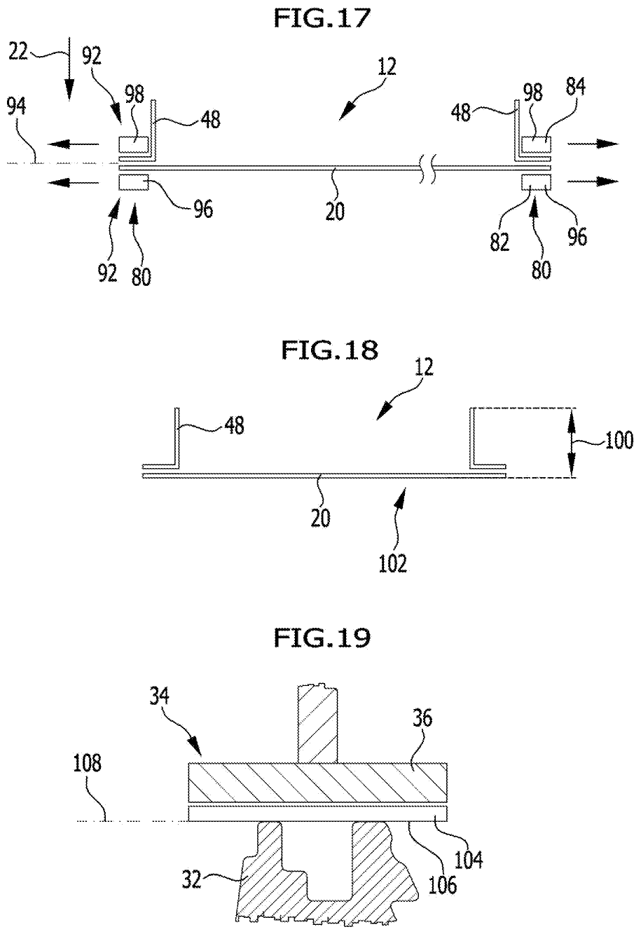

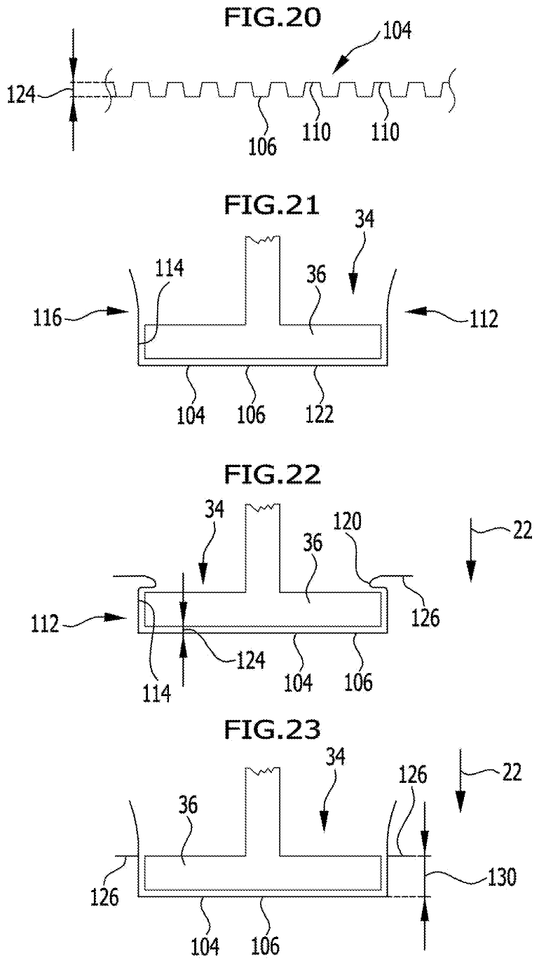

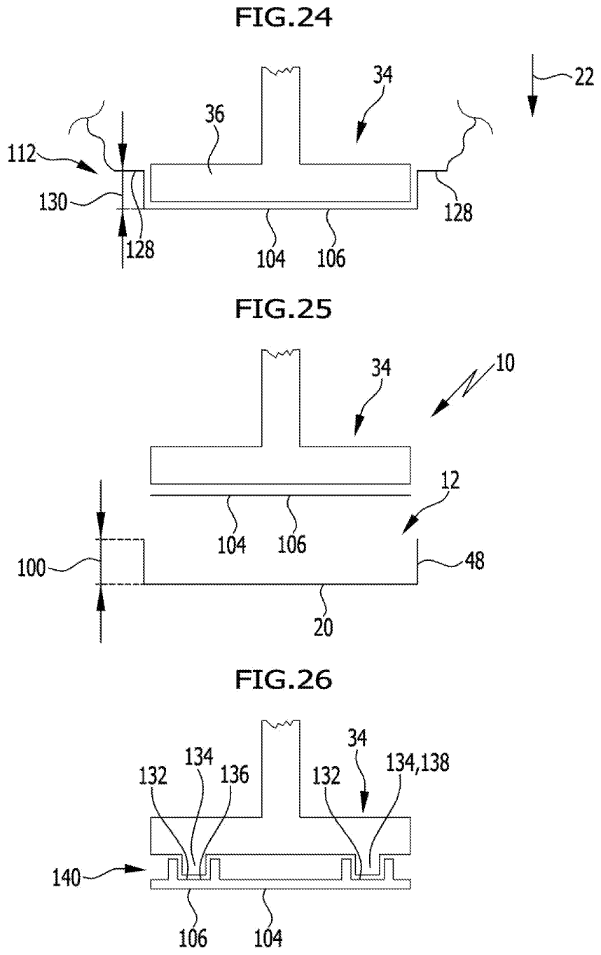

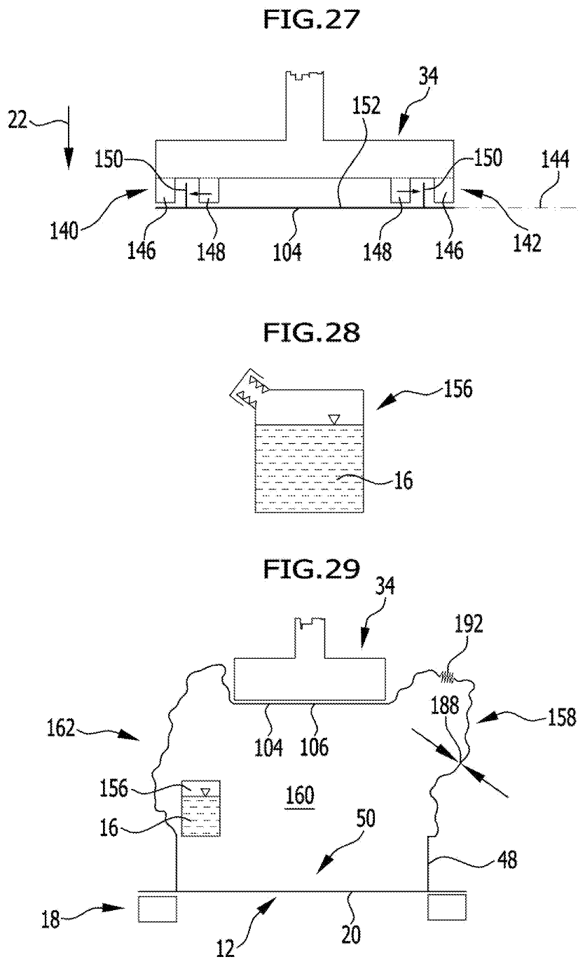

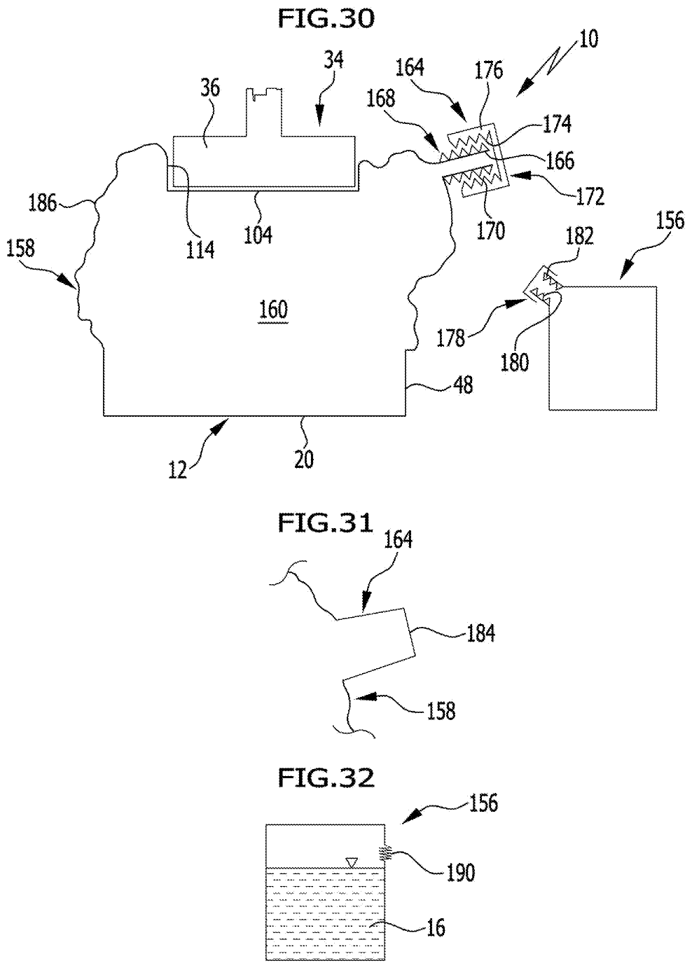

In one embodiment of a system 10, the tensioning device 92 is also configured such that cooperating first and second tensioning elements 96 and 98, which engage on a side of the container 12, can be moved away from one another relative to other tensioning elements 96 and 98, which engage on the container 12 at a different position, in order to tension the container base. For example, they can be moved away from one another in parallel to the container base 20. This is depicted schematically in FIG. 17 by the small arrows that are associated with the tensioning elements 96 and 98.

In one embodiment of a system 10, the holding device 18 comprises the connecting device 80. This makes it possible to hold the container 12 in the manner required for the manufacture of three-dimensional objects 32, and in particular to connect the container wall 48 and the container base 20 to one another in the described variants of containers 12, in particular with and without a connecting layer 66, independently of where the connecting layer 66 is concretely arranged or formed.

The container wall 48 defines a container wall height 100, which in the described embodiments of containers 12 has a value of in a range of about 1 mm to about 40 mm. In particular, it has a value in a range of about 4 mm to about 10 mm.

All embodiments of containers 12 described above are preferably configured in the form of disposable containers 102. The containers 12, if they are configured as disposable containers 102, are filled with solidifiable material 16 to manufacture three-dimensional objects 32. When the three-dimensional objects 32 to be printed are completed, the disposable containers 102 are not cleaned, but rather, for example, subjected to radiation 30 in order to through-harden the not yet cured solidifiable material 16. The disposable containers 102 with the cured excess solidifiable material can then be disposed of in a simple and environmentally friendly manner. An elaborate cleaning of the containers 12 is thus not necessary.

In a further embodiment of a system 10 for manufacturing a three-dimensional object 32, the system 10 comprises one or more support elements 104 for holding the three-dimensional object 32 made from the solidifiable material 16.

One embodiment of a support element 104 is configured to releasably couple to the support device 34 of the system 10 in a coupling position.

The support element 104 defines a holding surface 106 facing away from the support device 34, on which the three-dimensional object 32 is held. The holding surface 106 is made from a plastic.

In one embodiment of a support element 104, the holding surface 106 defines a holding surface plane 108.

In one embodiment of a support element 104, the holding surface 106 is of structured configuration. It has a plurality of stabilization grooves 110 in order to configure the support element to be self-supporting.

One embodiment of a system 10 comprises a support device cover 112 for the support device 34. In one embodiment, the support device cover 112 comprises the support element 104.

One embodiment of a support device cover 112 defines a support device receptacle 114 into which the support device 34 is completely or partially inserted in a positive-locking or substantially positive-locking manner in the coupling position. In particular, the holding plate 36 engages into the support device receptacle 114.

One embodiment of a support device 112 cover is configured in the form of a sheath 116, which comprises or defines the support device receptacle 114.

A further embodiment of a support device cover 112 is configured in the form of a deep-drawn blister 118, which comprises or defines the support device receptacle 114. The deep-drawn blister may, in particular, be configured in such a way that it can be clipped onto the holding plate 36 of the support device 34. This can be achieved, for example, by a peripheral recessed rim 120, which engages in the manner of a flange behind the holding plate 36 in the coupling position.

All described embodiments of support device covers 112 are preferably made from a plastic.

In one embodiment of a system 10, the support element(s) 104 is/are also made from a plastic.

In one embodiment of a system 10, the support element 104 is formed in one piece.

A further embodiment of a support device cover 112 is formed in one piece.

A further embodiment of a support device 104 is configured in the form of a film 121 or is made from a film 122.

In one embodiment, the support element 104 is of elastic and/or flexible configuration.

The described embodiments of support elements 104 have a thickness 124 in a range of about 0.1 mm to about 0.8 mm. In particular, a thickness 124 is in a range of about 0.1 to about 0.5 mm.

One embodiment of a support device cover 112 has a peripheral, radially protruding retaining flange 126, which in the coupling position extends transversely, in particular perpendicularly, to the direction of gravity.

One embodiment of a support device cover 112 has a peripheral, radially projecting retaining edge 128, which in the coupling position extends transversely, in particular perpendicularly, to the direction of gravity 22.

In one embodiment of the system 10, the support element 104 is arranged or formed opposite or substantially opposite the container base 20 of the container 12.

It is self-evident that all embodiment of containers 12 described above can be combined as desired with all embodiments of support elements 104 or support element covers 112 described above.

In one embodiment of a system 10, the holding surface 106 of the support element 104 is arranged or formed facing in the direction or substantially in the direction toward the container base 20.

As already described above, in one embodiment of a system 10, the support element 104 and the container base 20 are arranged or formed so as to be movable relative to one another.

In one embodiment of a system 10, the retaining flange 126 or the retaining edge 128 has a retaining distance 130 from the holding surface 106, which corresponds at least approximately to the container height 104. This ensures that even when the support device cover 112 dips so far into the container 12 that the holding surface 106 contacts the container base 20, the retaining flange 126 or the retaining edge 128 cannot come into contact with or only minimally come into contact with the solidifiable material 16 accommodated in the material receiving space 50. Flow around the support device 34, for example the holding plate 36, can be effectively prevented in this way.

In one embodiment of a system 10, the support element 104 comprises one or more first support element coupling elements 132, which in the coupling position are in engagement in a force- and/or positive-locking manner with one or more second support element coupling elements 134 of the support device 34.

In one embodiment of a support element 104, each first support element coupling element 132 is optionally configured in the form of a coupling projection or in the form of a coupling recess 136. Each second support element coupling element 134 is formed corresponding to the respective first support element coupling element 132 either in the form of a coupling recess or in the form of a coupling projection 138.

In one embodiment of a system 10, the support element 104 and the support device 34 in the coupling position are clampingly and/or latchingly and/or adhesively coupled to one another. For this purpose, the system 10 may, in particular, comprise a support element coupling device 140 for coupling the one or more support elements 104 and the support device 34 in the coupling position in a force-locking and/or positive-locking and/or substance-to-substance bonded manner.

In one embodiment of a system 10, the support element coupling device 140 comprises the first and second support element coupling elements 132 and 134, which are arranged or formed cooperatively for coupling the support element 104 and the support device 34 in the coupling position in a force-locking and/or positive-locking and/or substance-to-substance bonded manner.

In one embodiment of a system 10, the support element coupling device 140 comprises a clamping apparatus 142 for clampingly fixing the support element 104 to the support device 34 in a support element plane 144.

In one embodiment of a system 10, the support element plane 144 extends preferably transversely, in particular perpendicularly to the direction of gravity 22.

The clamping apparatus 142 may, in particular, comprise a plurality of first clamping members 146 and a plurality of second clamping members 148, which are each arranged and formed cooperatively. In particular, the first and second clamping members 146 and 148 are arranged or formed so as to be movable relative to one another, such that, for example, a holding projection 150, which protrudes from the support element 104 from a rear side 152 thereof, is introducible between a respective first clamping member 146 and a respective second clamping member 148. These can then be moved toward one another in order to clamp the holding projection 150 between them.

In the described manner, the clamping apparatus 142 may, in particular, be configured in such a way that the support element 104, in particular if it is made from a film 122, can be held under tension on the support device 134.

If the support element 104 is coupled to the support device 34, the support element 104 can be moved together with the support device 34 by means of the drive device 42 in a direction in parallel or substantially in parallel to the direction of gravity and counter to the direction of gravity.

In particular, it is possible in this way to move the support element 104 in the coupling position in parallel or substantially in parallel to the direction of gravity in the direction toward the container base 20 and away from the container base 20 by means of the drive device 42.

All described embodiments of support elements 104 can be configured, in particular, as disposable support elements 154. If they are, for example, formed in one piece with the support device cover 112, the support device cover is then configured for single use or for use for a small number of printing operations.

All embodiments of support elements 104 can be easily and securely coupled to the support device 34 in the coupling position in the described manner. The three-dimensional object 32 can then be formed in the known manner by curing the solidifiable material 16. When the three-dimensional object 32 is completed, the support element 104 is decoupled form the support device 34. The support device 34 is then ideally not contaminated with the solidifiable material 16 and therefore does not have to be cleaned.

The completed three-dimensional object 32 can now be removed from the support element 104. Solidifiable material that has not hardened and that is adhering to the support element 104 or to the support device cover 112 can be hardened by means of additional exposure to the radiation 30. The disposable support element 154 can then be disposed of in a simple, secure and, in particular, environmentally-friendly manner after the excess, not solidifiable material is cured. It is not necessary to clean the support element 104 in this case.

To form the next three-dimensional object, a new support element 104 or a new support device cover 112 is coupled to the support device.

The embodiments of containers 12 and support elements 104 or support device covers 112 described thus far are formed separate from one another and form discrete components. This means that the containers 12 can be inserted into the system 10 separately from the support elements 104 or the support device covers 112. This makes it possible to combine the above-described embodiments of support elements 104 or support device covers 112 and containers 12 in any way.

The solidifiable material 16 can be provided, in particular, in a material container 156. The solidifiable material 16 can then be filled as required from the material container 156 into the material receptacle 50 of the container 12.

In a further embodiment of a system 10, a container shroud 158 is provided, which defines a container inner space 160. The container 12 itself forms part of the container shroud 58, such that the container inner space 160 comprises the material receiving space 50. The container shroud 158 is of closed configuration and further comprises the support element 104, the holding surface 106 of which delimits the container inner space 160.

Configuring a container 12 with the described container shroud 158 makes it possible to form the three-dimensional object 32 completely enclosed by the container shroud 158. A sort of capsule 162 is formed in which the manufacture of the three-dimensional object 32 takes place.

In one embodiment of a container 12, the container base and the container wall form part of the container shroud 158.

In one embodiment of a container 12, the container shroud 158 is completely closed. Arranged in the container inner space 160 is a material container 156, which contains the solidifiable material 16. Said material container may be equipped with a predetermined breaking point and then, when the container shroud 158 with the support element 104 is coupled to the support device 134 and the container 12 is held on the holding device 18, it can be opened in order to introduce the solidifiable material 16 into the material receiving space 50. The three-dimensional object 32 can now be formed in the known manner. When the three-dimensional object 32 is completely formed, the container shroud 158 as a whole can be removed from the system 10.

To remove the three-dimensional object 32, the container shroud 158 is irreversibly destroyed, for example. Non-solidified solidifiable material 16 can be completely cured by means of suitable exposure to light, such that the container 12 may be configured, in particular, in the form of a disposable container 102, which comprises the container shroud 158. The disposable container 102 can be disposed of, as already described above, in a secure and, above all, environmentally friendly manner.

The container 12 with the container shroud 158 may, in particular, be configured in the form of one of the embodiments of containers 12 described above. Further, the support element 104 may also be configured in the form of one of the embodiments described above. Thus, any combinations of embodiments of containers 12 and support elements 104 can be combined with one another and be formed to a closed capsule 162 by means of a container shroud 158.

In a further embodiment of a system 10, the container 12 comprises an interface device 164 arranged or formed on the container shroud 158 for introducing the solidifiable material 16 through the container shroud 158 into the container inner space 160.

In one embodiment of a container 12, the interface device 164 forms an opening 166. For example, said opening may be formed on a connecting piece 168, which is of sleeve-shaped configuration and has an external thread 170.

To close the opening 166, in one embodiment of a container 12, a closure element 172 is provided, which has a screw connection 176 provided with an internal thread 174, which internal thread 174 is formed corresponding to the external thread 170.

Instead of the external thread 170, which forms a threaded portion, the interface device 164 may also be configured in the form of a bayonet connection for releasably connecting to a corresponding material container interface device 178.

In one embodiment of a material container 156, the material container interface device 178 is configured in the form of a filler neck 182 provided with an internal thread 180, wherein the internal thread 180 is formed corresponding to the external thread 170 of the interface device 164. The material container 156 can thus, in particular, be screwed onto the container shroud 158. Thus, in particular a fluid-tight, i.e. moisture-tight and/or gas-tight, connection between the material container 156 and the container shroud 148 in a filling position can be formed, such that the solidifiable material 16 can be easily and securely introduced into the material receiving space 50 in the container inner space 160.

In a further embodiment of a container 12, the interface device 164 comprises a membrane 184. Said membrane may be configured to be pierceable with a cannula in order to be able to thus introduce the solidifiable material into the container inner space 160.

In one embodiment of a container 12, the interface device 164 is arranged or formed at a distance from the container base 20. In particular, in one embodiment of a container 12, it is not arranged or formed on the container wall 48.

In a further embodiment of a container 12, the interface device 164 is arranged or formed in or on the container wall 48.

The container shroud 158, in one embodiment of a container 12, is made from a film 186.

In one embodiment of a container 12, the film 186 is of elastic and/or flexible configuration.

In the described embodiments of containers 12, the container shroud 158 has a thickness 188 in a range of about 0.05 mm to about 1.5 mm. In particular, it has a range of about 0.1 mm to about 0.6 mm.

The container shroud 158, in one embodiment of a container 12, is made from a plastic.

The container shroud, in one embodiment of a container 12, is formed in one piece.

In a further embodiment of a container 12, the container shroud 158 is formed in one piece, aside from the container base 20, i.e. with the exception of the container base 20. In this way, the container 12 can be configured, as described above in different embodiments of containers 12, in such a way that the container base 20 and the container wall 48 are each made from a different material.

In one embodiment of a container 12, the container shroud 158 is configured in such a way that the support element 104 is arranged or formed opposite or substantially opposite the container base 20. Accordingly, the holding surface 106 is then also arranged or formed facing in the direction or substantially in the direction toward the container base 20.

In one embodiment of a container 12, the container shroud 158 comprises one of the embodiments of support device covers 112 described above. In particular, the support device cover 112 is an integral part of the container shroud 158.

In a further embodiment of a system 10, a material container 156 is equipped with a predetermined breaking point 190, which can be irreversibly destroyed to open the material container 156.

In a further embodiment of a container 12, the container shroud 158 is openable only by means of destruction for removing the solidified three-dimensional object. Such a container shroud 158 may, in particular, comprise a container shroud predetermined breaking point 192, which can be irreversibly destroyed in order to open the container shroud 158 to remove the three-dimensional object 32.

In a further embodiment of a container 12, the container shroud 158, with the exception of the container base 20, is configured to be impermeable or substantially impermeable to the radiation 30 used to solidify the solidifiable material 16. In particular, the container shroud 158 may be configured to be impermeable to electromagnetic radiation 30 in a wavelength range of 200 nm to about 1000 nm.

In a further embodiment of a container 12, the container shroud 158, with the exception of the container base 20, is made from a container shroud material, which has a transmittance of at most 10% for the radiation 30 used to solidify the solidifiable material 16. In particular, the transmittance may be at most 1%.

The embodiments of systems 10 as well as individual components thereof described above, i.e. in particular the described embodiments of containers 12 and support elements 104 as well as support device covers 112, can be combined with one another as desired, provided this is not directly prevented on account of a concrete construction.

All described embodiments of systems 10 or components of such systems 10 enable an improved handling of said systems 10 and their components for the manufacture of three-dimensional objects 32. In particular, they have the advantage that a cleaning effort can be significantly reduced or that a cleaning of the systems 10 or the components thereof that are used multiple times is no longer necessary at all.

In particular, a practically odor-free use of the system 10 can be made possible when using a container 12 with a container shroud 158. This is advantageous in particular when the solidifiable material 16 has a very strong odor or emits gases that are harmful to health.

### REFERENCE NUMERAL LIST

10 system
12 container
14 tray
16 material
18 holding device
20 container base
22 arrow
24 support
26 exposure device
28 radiation source
30 radiation
32 three-dimensional object
34 support device
36 holding plate
38 underside
40 holding surface
42 drive device
44 control device
46 computer
48 container wall
50 material receiving space
52 film
54 thickness
56 separating element
58 non-stick layer
60 container wall frame
62 film
64 thickness
66 connecting layer
68 adhesive tape
70 cross sectional area
72 flange portion
74 end
76 container wall flange portion
78 container wall flange
80 connecting device
82 first connecting element
84 second connecting element
86 clamping device
88 first clamping element
90 second clamping element
92 tensioning device
94 container base plane
96 first tensioning element
98 second tensioning element
100 container wall height
102 disposable container
104 support element
106 holding surface
108 holding surface plane
110 stabilization groove
112 support device cover
114 support device receptacle
116 sheath
118 deep-drawn blister
120 rim
122 film
124 thickness
126 retaining flange
128 retaining edge
130 retaining distance
132 first support element coupling element
134 second support element coupling element
136 coupling recess
138 coupling projection
140 support element coupling device
142 clamping apparatus
144 support element plane
146 first clamping member
148 second clamping member
150 holding projection
152 rear side
154 disposable support element
156 material container
158 container shroud
160 container inner space
162 capsule
164 interface device
166 opening
168 connecting piece
170 external thread
172 closure element
174 internal thread
176 screw connection
178 material container interface device
180 internal thread
182 filler neck
184 membrane
186 film
188 thickness
190 predetermined breaking point
192 container shroud predetermined breaking point

1. A system for manufacturing a three-dimensional object by solidifying, in particular in layers or continuously, a material that is solidifiable under the effect of radiation, which system comprises a container for receiving the solidifiable material, in which container the solidifiable material is solidified in layers or continuously by the effect of radiation for manufacturing the three-dimensional object, wherein the container comprises a container base and a peripheral container wall projecting from the container base, wherein the container base and the container wall delimit a material receiving space for receiving the solidifiable material, wherein the container defines a container inner space surrounded by a container shroud, wherein the container inner space comprises the material receiving space, wherein the container shroud is closed and wherein the container shroud comprises a support element, which defines a holding surface for holding the three-dimensional object formed from the solidifiable material, wherein the container has an interface device arranged on the container shroud for introducing the solidifiable material through the container shroud into the container inner space and wherein the interface device comprises an opening and/or a membrane, in particular pierceable.

2. The system in accordance with claim 1, comprising at least one of the following:
a) the container base and/or the container wall form part of the container shroud;
b) the interface device comprises a threaded portion or a bayonet connection for releasably connecting to a corresponding material container interface device of a material container filled with solidifiable material;
c) the interface device is arranged or formed at a distance from the container base, in particular not in the container wall;
d) the interface device is arranged or formed in or on the container wall.

3. The system in accordance with claim 1, wherein the container base at least one of the following:
a) is made from a different material than the container wall;
b) is configured to be transmissive to the radiation used to solidify the solidifiable material, in particular to electromagnetic radiation in a wavelength range of about 200 nm to about 1000 nm;
c) is configured in the form of a separating element;
d) is provided with a non-stick layer delimiting the material receiving space or is made from a container base material that does not adhere or adheres little to the solidified material;
e) is configured in the form of a film or is made from a film;
f) is of elastic and/or flexible configuration;
g) has a thickness in a range of about 0.05 mm to about 3 mm, in particular in a range of about 0.07 mm to about 0.3 mm;
h) is made from a plastic, in particular from polytetrafluoroethylene (PTFE), perfluoroalkoxy polymer (PFA), ethylene tetrafluoroethylene copolymer (ETFE) and/or tetrafluoroethylene hexafluoropropylene copolymer (FEP).

4. The system in accordance with claim 1, wherein the container wall at least one of the following:
a) extends perpendicularly or substantially perpendicularly away from the container base;
b) is configured to be self-supporting, in particular in the form of a self-enclosed annular container wall frame.

5. The system in accordance with claim 1, wherein the container shroud at least one of the following:
a) is made at least partially from a film, wherein in particular the film is of elastic and/or flexible configuration;
b) has a thickness in a range of about 0.05 mm to about 1.5 mm, in particular in a range of about 0.1 mm to about 0.6 mm;
c) is made from a plastic;
d) is formed in one piece, in particular except for the container base.

6. The system in accordance with claim 1, wherein at least one of the following:
a) the support element is arranged or formed opposite or substantially opposite the container base;
b) the holding surface is arranged or formed facing in the direction or substantially in the direction toward the container base.

7. The system in accordance with claim 1, wherein the support element is configured to releasably couple to a movably formed or arranged support device of the system in a coupling position.

8. The system in accordance with claim 7, wherein at least one of the following:
a) the support element comprises at least one first support element coupling element, which in the coupling position is in force- and/or positive-locking engagement with at least one second support element coupling element of the support device;
b) the holding surface, in particular in the coupling position, is of planar or substantially planar configuration or the holding surface is of structured configuration, in particular comprising a plurality of stabilization grooves.

9. The system in accordance with claim 1, wherein the container shroud comprises a support device cover for a support device of the system, and wherein the support device cover comprises the support element.

10. The system in accordance with claim 9, wherein at least one of the following:
a) the support device cover defines a support device receptacle, into which the support device or a part thereof is at least partially introducible in a positive-locking or substantially positive-locking manner;
b) the support device cover is configured in the form of a sheath or a deep-drawn blister, which comprise or define the support device receptacle;
c) the support device cover is made from a plastic;
d) the support device cover has a peripheral, radially protruding retaining flange or a peripheral, radially projecting retaining edge, which retaining flange or retaining edge in the coupling position runs transversely, in particular perpendicularly, to the direction of gravity.

11. The system in accordance with claim 1, wherein the support element and the container base are arranged or formed so as to be moveable relative to one another.

12. The system in accordance with claim 1, wherein the system further comprises a material container filled with solidifiable material.

13. The system in accordance with claim 12, wherein the material container at least one of the following:
a) is comprised by the container;
b) is arranged or formed at least partially, in particular entirely, in the material receiving space defined by the container;
c) has at least one predetermined breaking point for opening same;
d) comprises a material container interface device for coupling, in particular for coupling in a fluid-tight manner, to the interface device of the container in a filling position.

14. The system in accordance with claim 1, wherein the container shroud at least one of the following:
a) is openable only by means of destruction, in particular by destroying a container shroud predetermined breaking point, for removing the solidified three-dimensional object;
b) with the exception of the container base is configured to be impervious or substantially impervious to the radiation used to solidify the solidifiable material, in particular to electromagnetic radiation in a wavelength range of about 200 nm to about 1000 nm;
c) except for the container base has a transmittance of at most 10%, in particular at most 1%, to the radiation used to solidify the solidifiable material, in particular to electromagnetic radiation in a wavelength range of about 200 nm to about 1000 nm.

15. The system in accordance with claim 1, wherein at least one of the following:
a) the system comprises a holding device for holding the container, such that the container base is arranged in space transversely, in particular perpendicularly, to the direction of gravity and the container wall extends away from the container base counter to or substantially counter to the direction of gravity;
b) the system comprises a support device and a drive device that cooperates with the support device for moving the support device, in particular the support element in the coupling position, relative to the container base;
c) the system further comprises an exposure device for exposing the solidifiable material to light, in particular in layers or continuously, by subjecting it to radiation, in particular electromagnetic radiation;
d) the container is configured in the form of a disposable container.

16. A system for manufacturing a three-dimensional object by solidifying, in particular in layers or continuously, a material that is solidifiable under the effect of radiation, which system comprises a container for receiving the solidifiable material, in which container the solidifiable material is solidified in layers or continuously by the effect of radiation for manufacturing the three-dimensional object, wherein the container comprises a container base and a peripheral container wall projecting from the container base, wherein the container base and the container wall delimit a material receiving space for receiving the solidifiable material, wherein the container defines a container inner space surrounded by a container shroud, wherein the container inner space comprises the material receiving space, wherein the container shroud is closed and wherein the container shroud comprises a support element, which defines a holding surface for holding the three-dimensional object formed from the solidifiable material, wherein the container has an interface device arranged on the container shroud for introducing the solidifiable material through the container shroud into the container inner space and wherein the interface device comprises a threaded portion or a bayonet connection for releasably connecting to a corresponding material container interface device of a material container filled with solidifiable material.

17. The system in accordance with claim 16, wherein the container base at least one of the following:
a) is made from a different material than the container wall;
b) is configured to be transmissive to the radiation used to solidify the solidifiable material, in particular to electromagnetic radiation in a wavelength range of about 200 nm to about 1000 nm;
c) is configured in the form of a separating element;
d is provided with a non-stick layer delimiting the material receiving space or is made from a container base material that does not stick or sticks little to the solidified material;
e) is configured in the form of a film or is made from a film;
f) is of elastic and/or flexible configuration;
g) has a thickness in a range of about 0.05 mm to about 3 mm, in particular in a range of about 0.07 mm to about 0.3 mm;
h) is made from a plastic, in particular from polytetrafluoroethylene (PTFE), perfluoroalkoxy polymer (PFA), ethylene tetrafluoroethylene copolymer (ETFE) and/or tetrafluoroethylene hexafluoropropylene copolymer (FEP).

18. A system for manufacturing a three-dimensional object by solidifying, in particular in layers or continuously, a material that is solidifiable under the effect of radiation, which system comprises a container for receiving the solidifiable material, in which container the solidifiable material is solidified in layers or continuously by the effect of radiation for manufacturing the three-dimensional object, wherein the container comprises a container base and a peripheral container wall projecting from the container base, wherein the container base and the container wall delimit a material receiving space for receiving the solidifiable material, wherein the container defines a container inner space surrounded by a container shroud, wherein the container inner space comprises the material receiving space, wherein the container shroud in closed, and wherein the container shroud comprises a support element, which defines a holding surface for holding the three-dimensional object formed from the solidifiable material, wherein the container has an interface device arranged on the container shroud for introducing the solidifiable material through the container shroud into the container inner space, and wherein the interface device is arranged or formed at a distance from the container base, in particular not in the container wall.

19. The system in accordance with claim 18, wherein the interface device comprises an opening and/or a membrane, in particular pierceable.

20. The system in accordance with claim 18, wherein the container base at least one of the following:
a) is made from a different material than the container wall;
b) is configured to be transmissive to the radiation used to solidify the solidifiable material, in particular to electromagnetic radiation in a wavelength range of about 200 nm to about 1000 nm;
c) is configured in the form of a separating element;
d) is provided with a non-stick layer delimiting the material receiving space or is made from a container base material that does not stick or sticks little to the solidified material;
e) is configured in the form of a film or is made from a film;
f) is of elastic and/or flexible configuration;
g) has a thickness in a range of about 0.05 mm to about 3 mm, in particular in a range of about 0.07 mm to about 0.3 mm;
h) is made from a plastic, in particular from polytetrafluoroethylene (PTFE), perfluoroalkoxy polymer (PFA), ethylene tetrafluoroethylene copolymer (ETFE) and/or tetrafluoroethylene hexafluoropropylene copolymer (FEP).
